(19) United States
(12) Patent Application Publication
(10) Pub. No.: US 2020/0196137 A1
(43) Pub. Date: Jun. 18, 2020

(54) SYSTEMS AND METHODS FOR INCREASING SECURITY IN SYSTEMS USING MESH NETWORKS

(71) Applicant: Honeywell International Inc., Morris Plains, NJ (US)

(72) Inventors: Andrew G. Berezowski, Wallingford, CT (US); Jesse J. Otis, North Haven, CT (US); Jason Michael Farrell, Killingworth, CT (US)

(21) Appl. No.: 16/222,021

(22) Filed: Dec. 17, 2018

(51) Int. Cl. H04W 12/00; H04L 29/06; H04L 29/08; H04L 12/24; H04W 12/08; H04W 12/10

(52) U.S. Cl. CPC H04W 12/009; H04W 12/002; H04L 63/12; H04L 67/14; H04L 41/0866; H04W 84/18; H04W 12/0802; H04W 12/0806; H04W 12/1006; H04L 41/06; H04W 12/00512

(57) ABSTRACT

Systems and methods for increasing security in security systems and alarm systems that use mesh networks are provided. In some embodiments, such systems and methods can include a mesh controller activating diagnostic, configuration, and control functions of a service device in response to physical activation of the a verification device, the service device using the diagnostic, configuration, and control functions of the service device to add a new mesh element to a plurality of mesh elements, and one of the plurality of mesh elements detecting a signal transmitted during an assigned time slot of the one of the plurality of mesh elements from a device other than the one of the plurality of mesh elements and, responsive thereto, disrupting transmission of the signal.

### FIELD

The present invention relates generally to security systems and alarm systems. More particularly, the present invention relates to systems and methods for increasing security in security systems and alarm systems that use mesh networks.

### BACKGROUND

Known systems and methods that employ mesh networks are vulnerable to security breaches through hacking or spoofing by devices located outside of a secured facility, which can result in malicious activity that is not easily discovered.

In view of the above, there is a continuing, ongoing need for improved systems and methods.

### BRIEF DESCRIPTION OF THE DRAWINGS

FIG. 1 is a block diagram of a system in accordance with disclosed embodiments; and

FIG. 2 is a flow diagram of a method in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein may include systems and methods for increasing security in security systems and alarm systems that use mesh networks. For example, systems and methods disclosed herein can include a mesh controller, at least one verification device, a service device, and a plurality of mesh elements. In some embodiments, the service device can include, but is not limited to a mobile device, a computer, an integrated user interface of the mesh controller, and a smart phone among others.

The mesh controller can activate diagnostic, configuration, and control functions of the service device in response to physical activation of the at least one verification device, and the diagnostic, configuration, and control functions of the service device can relate to operation of the plurality of mesh elements. In some embodiments, the service device can add a new mesh element to the plurality of mesh elements using the diagnostic, configuration, and control functions of the service device.

In some embodiments, the at least one verification device can include a switch on the mesh controller or a presence sensor or other sensor, switch, or device in an area proximate to the mesh controller, and the physical activation of the at least one verification device can include at least one of toggling the switch on the mesh controller or tripping the presence sensor or the other sensor, switch, or device in the area proximate to the mesh controller. As such, the mesh controller can ensure that the service device is located within some predetermined area thereof prior to allowing the service device to execute any operation in connection with the plurality of mesh elements via the diagnostic, configuration, and control functions of the service device, thereby preventing attacks from devices located outside of that predetermined area of the mesh controller.

In some embodiments, the at least one verification device can be disconnected or isolated from outside networks, such as the internet, to further ensure that the at least one verification device is physically activated in proximity to the mesh controller.

In some embodiments, the mesh controller can establish a unique user session on the service device to activate the diagnostic, configuration, and control functions of the service device. Additionally or alternatively, in some embodiments, the mesh controller can terminate the unique user session after a predetermined period of time of inactivity or after expiration of a limited access period. Then, the mesh controller can require the physical activation of the at least one verification device before reestablishing the unique user session on the service device.

In some embodiments, each of the plurality of mesh elements can communicate with each other, the mesh controller, and/or the service device during a respective assigned time slot. Then, each of the plurality of mesh elements can detect signals transmitted during its assigned time slot from devices other than that one of the plurality of mesh elements and, responsive thereto, can disrupt transmission of those signals. For example, a first of the plurality of mesh elements can monitor the signals transmitted during its assigned time slot when the first of the plurality of mesh elements does not have any signals to transmit and can identify any signals transmitting during its assigned time slot as malicious and coming from a device other than the plurality of mesh elements, the mesh controller, and the service device because the first of the plurality of mesh elements should be the only device transmitting during its assigned time slot.

In some embodiments, each of the plurality of mesh elements can disrupt the signals transmitted during its assigned time slot by activating a respective transmitter to jam those signals. Additionally or alternatively, in some embodiments, each of the plurality of mesh elements can disrupt the signals transmitted during its assigned time slot by invalidating a CRC or checksum of those signals. In any embodiment, each of the plurality of mesh elements can generate a record of the signals disrupted and can transmit an alert indicative of the record to the mesh controller.

It should be understood that the plurality of mesh elements disrupting malicious signals can be done in conjunction with or separately from other security enhancing methods disclosed herein.

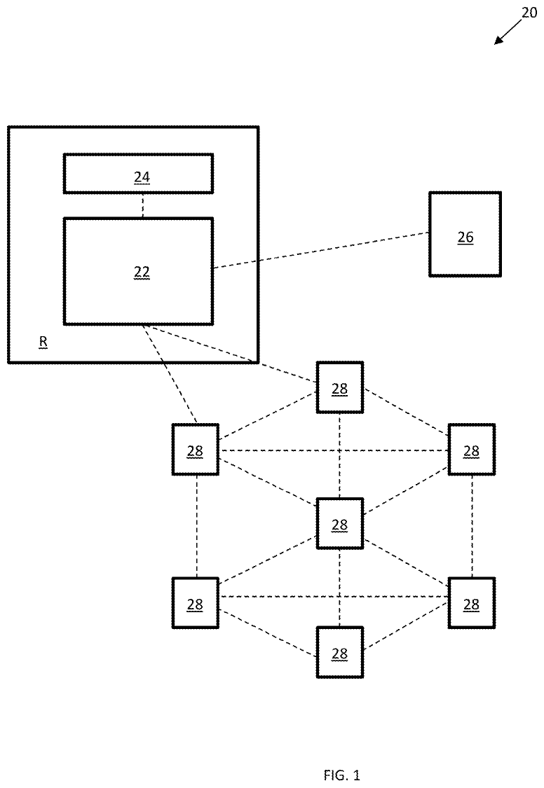

FIG. 1 is a block diagram of a system 20 in accordance with disclosed embodiments. The system 20 can include a mesh controller 22 located in a region R, a verification device 24 located proximate to the mesh controller in the region R, a service device 26, and a plurality of mesh elements 28, and each of the mesh controller 22, the verification device 24, the service device 26, and the plurality of mesh elements 28 can communicate with each other via a wired or wireless communication medium as known to persons of ordinary skill in the art. In some embodiments, the region R can include a locked or secured room of a larger facility in which the plurality of mesh elements 28 are deployed, and in some embodiments, the plurality of mesh elements can include sensors, detectors, fire alarms, smoke detectors, and/or announcers that are part of a security system or an alarm system deployed in the region R or the larger facility in which the region R is located.

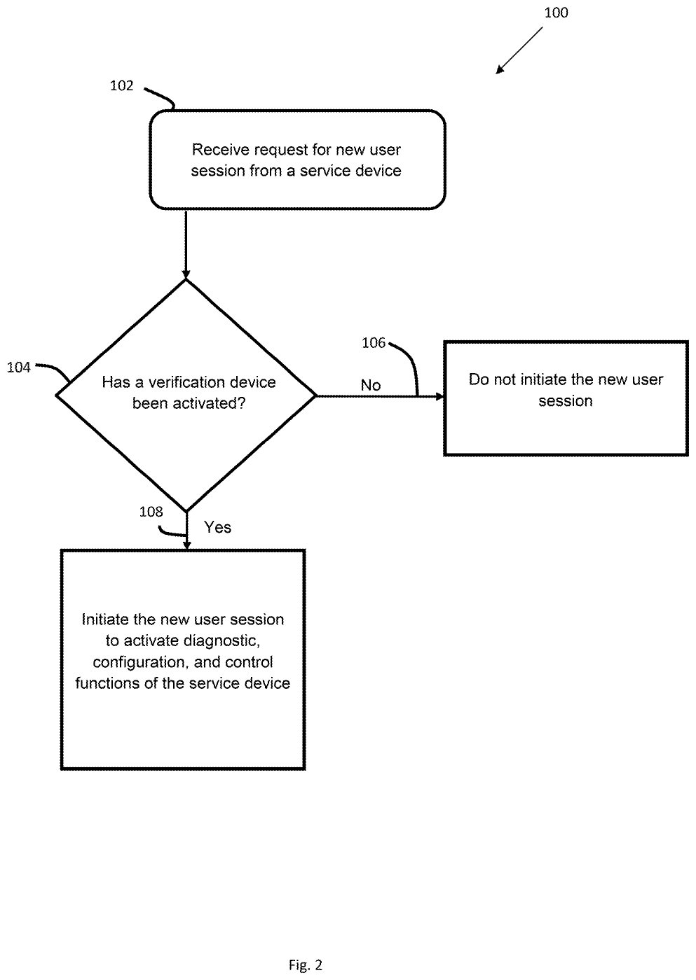

FIG. 2 is a flow diagram of a method 100 in accordance with disclosed embodiments. As seen in FIG. 2, the method 100 can include the mesh controller 22 receiving a request for a new user session from the service device 26, as in 102, and the mesh controller 22 determining whether the verification device 24 located proximate to the mesh controller 22 has been physically activated, as in 104. When the mesh controller 22 determines that the verification device 24 has not been physically activated, the method 100 can include the mesh controller 22 refusing to initiate the new user session requested, as in 106. However, when the mesh controller 22 determines that the verification device 24 has been physically activated, the method 100 can include the mesh controller 22 initiating the new user session requested to activate diagnostic, configuration, and control functions of the service device 26 for operating on the plurality of mesh elements 28, as in 108.

It is to be understood that each of the mesh controller 22, the verification device 24, the service device 26, and the plurality of mesh elements 28 disclosed herein can include a respective transceiver device and a respective memory device, each of which can be in communication with respective control circuitry, one or more respective programmable processors, and respective executable control software as would be understood by one of ordinary skill in the art. In some embodiments, the respective executable control software of each of the mesh controller 22, the verification device 24, the service device 26, and the plurality of mesh elements 28 can be stored on a respective transitory or non-transitory computer readable medium, including, but not limited to local computer memory, RAM, optical storage media, magnetic storage media, flash memory, and the like, and some or all of the respective control circuitry, the respective programmable processors, and the respective executable control software of each of the mesh controller 22, the verification device 24, the service device 26, and the plurality of mesh elements 28 can execute and control at least some of the methods described herein.

Although a few embodiments have been described in detail above, other modifications are possible. For example, the steps described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A system comprising:
a mesh controller;
a verification device;
a service device; and
a plurality of mesh elements,
wherein the mesh controller activates diagnostic, configuration, and control functions of the service device in response to physical activation of the verification device, and
wherein the diagnostic, configuration, and control functions of the service device relate to operation of the plurality of mesh elements.

2. The system of claim 1 wherein the service device uses the diagnostic, configuration, and control functions to add a new mesh element to the plurality of mesh elements.

3. The system of claim 1 wherein each of the plurality of mesh elements communicates during a respective assigned time slot, and wherein one of the plurality of mesh elements detects a signal transmitted during the respective assigned time slot of the one of the plurality of mesh elements from a device other than the one of the plurality of mesh elements and, responsive thereto, disrupts transmission of the signal.

4. The system of claim 3 wherein the one of the plurality of mesh elements disrupts the transmission of the signal by activating a transmitter of the one of the plurality of mesh elements to jam the transmission of the signal.

5. The system of claim 3 wherein the one of the plurality of mesh elements disrupts the transmission of the signal by invalidating a CRC or checksum of the signal.

6. The system of claim 3 wherein the one of the plurality of mesh elements generates a record of the signal and transmits an alert indicative of the record to the mesh controller.

7. The system of claim 1 wherein the verification device includes a switch on the mesh controller, and wherein the physical activation of the verification device includes toggling the switch.

8. The system of claim 1 wherein the verification device includes one of a presence sensor or other sensor, switch, or device located proximate to the mesh controller, and wherein the physical activation of the verification device includes tripping the presence sensor or the other sensor, switch, or device located proximate to the mesh controller.

9. The system of claim 1 wherein the mesh controller establishes a unique user session on the service device to activate the diagnostic, configuration, and control functions of the service device.

10. The system of claim 9 wherein the mesh controller terminates the unique user session after a predetermined period of time of inactivity.

11. A method comprising:
a mesh controller receiving a request for a unique user session from a service device;
the mesh controller determining whether a verification device has been physically activated; and
responsive to the mesh controller determining that the verification device has been physically activated, the mesh controller activating diagnostic, configuration, and control functions of the service device,
wherein the diagnostic, configuration, and control functions of the service device relate to operation of a plurality of mesh elements.

12. The method of claim 11 further comprising the service device using the diagnostic, configuration, and control functions of the service device to add a new mesh element to the plurality of mesh elements.

13. The method of claim 11 wherein the mesh device determining whether the verification device has been physically activated includes the mesh device determining whether a switch on the mesh controller has been toggled.

14. The method of claim 11 wherein the mesh device determining whether the verification device has been physically activated includes the mesh device determining whether one of a presence sensor or other sensor, switch, or other device located proximate to the mesh controller has been tripped.

15. The method of claim 11 further comprising the mesh controller establishing the unique user session on the service device to activate the diagnostic, configuration, and control functions of the service device.

16. The method of claim 15 further comprising the mesh controller terminating the unique user session after a predetermined period of time of inactivity.

17. A method comprising:
one of a plurality of mesh elements communicating during an assigned time slot;
the one of the plurality of mesh elements detecting a signal transmitted during the assigned time slot of the one of the plurality of mesh elements from a device other than the one of the plurality of mesh elements; and
responsive to detecting the signal transmitted during the assigned time slot of the one of the plurality of mesh elements from the device other than the one of the plurality of mesh elements, the one of the plurality of mesh elements disrupting transmission of the signal.

18. The method of claim 17 further comprising the one of the plurality of mesh elements disrupting the transmission of the signal by activating a transmitter of the one of the plurality of mesh elements to jam the transmission of the signal.

19. The method of claim 17 further comprising the one of the plurality of mesh elements disrupting the transmission of the signal by invalidating a CRC or checksum of the signal.

20. The method of claim 17 further comprising:
the one of the plurality of mesh elements generating a record of the signal; and
the one of the plurality of mesh elements transmitting an alert indicative of the record.
